(19) United States
(12) Patent Application Publication
(10) Pub. No.: US 2025/0251565 A1
(43) Pub. Date: Aug. 7, 2025

(54) DRIVING ASSEMBLY, ZOOM LENS AND CAMERA DEVICE

(71) Applicant: ZHONGSHAN UNION OPTECH RESEARCH INSTITUTE CO., LTD., Zhongshan (CN)

(72) Inventors: Junqiang GONG, Zhongshan (CN); Meijiao ZHAO, Zhongshan (CN); Kun LI, Zhongshan (CN); Shengping QIU, Zhongshan (CN)

(73) Assignee: ZHONGSHAN UNION OPTECH RESEARCH INSTITUTE CO., LTD., Zhongshan (CN)

(21) Appl. No.: 18/613,554

(22) Filed: Mar. 22, 2024

(30) Foreign Application Priority Data
Feb. 6, 2024 (CN) 202410173409.7

(51) Int. Cl. G02B 7/10

(52) U.S. Cl. CPC G02B 7/102

(57) ABSTRACT

Disclosed are a driving assembly, a zoom lens and a camera device. The driving assembly includes a seat body structure, a voice coil motor, a position detection device and a control device. The voice coil motor includes a magnetic yoke, a magnetic body structure and a drive coil. The magnetic body structure is provided at the magnetic yoke. The magnetic body structure includes two magnetic circuit assemblies provided at intervals in an up and down direction, each of the magnetic circuit assemblies includes two magnetic bodies provided at intervals in the up and down direction, and the two magnetic bodies form a magnetic gap. The two wire groups of the drive coil are respectively provided in the magnetic gap formed by the two magnet magnetic bodies of the corresponding magnetic circuit assemblies. The two magnetic bodies generate a magnetic field that is strong enough.

### CROSS-REFERENCE TO RELATED APPLICATIONS

This application claims priority to Chinese Patent Application No. 202410173409.7, filed on Feb. 6, 2024, the content of which is incorporated herein by reference in its entirety.

### TECHNICAL FIELD

The present application relates to the field of camera driving technology, and in particular to a driving assembly, a zoom lens and a camera device.

### BACKGROUND

Conventional optical zoom lenses currently use stepper motor drive methods, which have low rotational speed and high power consumption, are susceptible to electromagnetic interference and noise, and have poor wear resistance. In the new long-stroke VCM (Voice Coil Motor) structure, the movement stroke of the mover is relatively long and the motor power is relatively large. However, when the stroke is too long, there will be a phenomenon of weak magnetic force in the middle of the magnet, thus, the motor power will be greatly affected. The longer the structural length, the smaller the magnetic field, and the smaller the driving force. At the same time, the existing position sensing method can only sense one position by PI, the control accuracy is low, and adverse phenomena such as out-of-step are prone to occur, which cannot meet the increasingly stringent accuracy requirements of today's customers.

### SUMMARY

The main purpose of the present application is to propose a driving assembly, a zoom lens and a camera device, aiming to provide a driving assembly with an ultra-long driving stroke and precise control of driving accuracy.

In order to achieve the above object, the present application proposes a driving assembly, including:
a seat body structure;
a voice coil motor including a mounting base fixedly connected to the seat body structure, a magnetic body structure and a drive coil, the magnetic body structure is fixed at the mounting base, and the magnetic body structure includes two magnetic circuit assemblies provided at intervals in an up and down direction, each of the magnetic circuit assemblies includes two magnetic bodies provided at intervals in the up and down direction, magnetic poles on sides of the two magnetic bodies close to each other are provided differently, and the two magnetic bodies are configured to form a magnetic gap extending along a front and rear direction; the drive coil includes two wire groups provided oppositely in the up and down direction, one of the wire groups is provided in a magnetic gap formed by two magnetic bodies of one magnetic circuit assembly, and the other of the wire groups is provided in a magnetic gap formed by two magnetic bodies of the other magnetic circuit assembly; when the drive coil is energized, the two magnetic circuit assemblies are configured to generate electromagnetic force with the drive coil, so as to drive the drive coil to drive a moving group fixed to the drive coil to move along the front and rear direction;
a position detection device configured for detecting a relative position of the drive coil and the magnetic body structure in real time; and
a control device electrically connected to the position detection device and the voice coil motor, and the control device is configured to control operation of the voice coil motor according to the position detection device.

In an embodiment, the position detection device includes a magnetic grating transducer including a magnetic head and a magnetic grid; the magnetic head is fixedly connected to the drive coil, and the magnetic grid is fixedly connected to the seat body structure.

In an embodiment, the position detection device includes an optical grating transducer including a scale grating and an indication grating; the scale grating is fixedly connected to the drive coil, and the indication grating is fixedly connected to the seat body structure.

In an embodiment, each of the magnetic bodies includes a plurality of magnets provided at intervals in sequence along the front and rear direction.

In an embodiment, the mounting base is configured as a magnetic yoke; the magnetic yoke is configured to form an installing groove provided with an opening, and the opening is provided at one side of the magnetic yoke in a left and right direction; the opening is configured to extend along the front and rear direction, and the magnetic body structure and the drive coil are both provided in the installing groove.

In an embodiment, the magnetic yoke includes two first magnetic yokes extending along the front and rear direction and provided at intervals in the up and down direction, and one side of each first magnetic yoke facing the other first magnetic yoke is fixed to one magnetic body; and

the installing groove is further provided with a second magnetic yoke located between the two magnetic circuit assemblies and extending along the front and rear direction, and two side parts of the second magnetic yoke in the up and down direction are respectively provided with one magnetic body.

In an embodiment, the driving assembly further includes a guide mechanism including a guide rail provided at one of the seat body structure and the moving group, and a slide block provided at the other of the seat body structure and the moving group; the guide rail is configured to extend along the front and rear direction; the slide block is concavely provided with a slide groove slidingly matched with the guide rail, and the guide mechanism further includes a rolling part provided between an inner wall of the slide groove and the guide rail; the moving group is supported at the guide rail by the rolling part when the moving group is configured to move relative to the seat body structure along the front and rear direction.

In an embodiment, the driving assembly further includes a wire harness and a track wire tube; one end of the wire harness is connected to the drive coil, and the other end of the wire harness is connected to a power supply; the track wire tube includes a plurality of tube sections, and every two adjacent tube sections are rotationally connected; the plurality of the tube sections are provided to be communicated in sequence to form an installation passage for the wire harness to be sleeved, and the wire harness is passed through the installation passage.

The present application further provides a zoom lens including the above-mentioned driving assembly.

In an embodiment, the zoom lens further includes: a lens barrel including the seat body structure; and a moving group fixedly connected to the drive coil.

The present application further provides a camera device including the above-mentioned zoom lens, and the camera device includes a security monitor, a photography camera, or an intelligent terminal equipment.

In the technical solution provided by the present application, since the drive coil is provided in an annular shape, the drive coil has two wire groups provided oppositely in the up and down direction, the magnetic body structure includes two magnetic circuit assemblies, and each of the magnetic circuit assemblies includes two magnet bodies with magnetic poles provided differently, and a magnetic gap is formed between the two magnetic bodies. A wire group is placed in the magnetic gap formed by the two magnetic bodies of a magnetic circuit assembly, and the other of the wire groups is placed in the magnetic gap formed by the two magnetic bodies of the other magnetic circuit assembly. When the drive coil is energized, the two wire groups are respectively in the magnetic field generated by the two magnetic bodies. According to Ampere's rule, the two wire groups are both affected by the Ampere force, so that both the upper side part of the drive coil and the lower side of the drive coil can be moved under the action of Ampere's force. Compared with the situation in the prior art where one side of the coil is in a magnetic field, or magnets are provided at two single sides of the coil, in the present application, both sides of the drive coil are placed in the magnetic gap formed by two magnetic bodies, the two magnetic bodies can generate a sufficiently strong magnetic field, when the moving stroke of drive coil is relatively long, the drive coil can also be in a relatively stronger magnetic field, two side parts of the drive coil are driven synchronously, and the driving force is also relatively strong. When the driving stroke of the driving assembly is longer, the demand for position accuracy of driving the moving group is higher, the position detection device adopts closed-loop control and can detect the position of the moving group in real time during the stroke of the moving group moving along the front and rear direction. Moreover, the control device adjusts the position of the moving group in real-time according to the displacement difference between the actual position of the lens group and the target position of the lens group, which is not limited by the physical accuracy and wear accuracy of the product itself of the driving mechanism, and is not affected by poor stopping accuracy when the driving assembly drives the moving group at high speed, so that the moving group can accurately reach the target position required for zooming or focusing, and the moving group control can achieve a position detection accuracy of more than 5 um, realizing multi-position induction detection, and accurately sensing any position driven by the voice coil motor, so as to propose a driving assembly that has an ultra-long driving stroke and can accurately control the driving accuracy.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those of ordinary skill in the art.

FIG. 1 is a three-dimensional schematic view of a zoom lens according to an embodiment provided by the present application.

FIG. 2 is a three-dimensional schematic view of a driving assembly according to an embodiment provided by the present application.

FIG. 3 is a three-dimensional schematic view of a voice coil motor and a moving group in FIG. 2.

FIG. 4 is an exploded schematic view of the voice coil motor in FIG. 2.

FIG. 5 is a three-dimensional schematic view of a position detection device and a moving group in FIG. 2.

FIG. 6 is a three-dimensional schematic view of a guiding structure and the moving group in FIG. 2.

FIG. 7 is a three-dimensional schematic view of a track wire tube and the moving group in FIG. 2.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those of ordinary skill in the art without making creative labor fall within the scope of the present application.

It should be noted that in the embodiment of the present application, all directional indications (such as up, down, left, right, front, back or the like) are only used to explain the relative positional relationship, movement and so on between various components in a specific posture (as shown in the accompanying drawings). If the specific posture changes, the directional indication will also change accordingly.

In addition, if there are descriptions involving “first”, “second” or the like in the embodiments of the present application, the descriptions of “first”, “second” or the like are only for descriptive purposes and cannot be understood as indicating or implying the relative importance or implicitly indicating the quantity of the technical features indicated. Therefore, features defined as “first” and “second” may explicitly or implicitly include at least one of these features. In addition, the meaning of “and/or” appearing in the entire text includes three parallel solutions, taking “A and/or B” as an example, it includes solution A, or solution B, or a solution that satisfies both A and B at the same time. In addition, the technical solutions of various embodiments can be combined with each other, but it is based on that those of ordinary skill in the art can realize. When the combination of technical solutions is contradictory or cannot be realized, it should be considered that such combination of technical solutions does not exist and is not within the protection scope claimed by the present application.

Conventional optical zoom lenses currently use stepper motor drive methods, which have low rotational speed and high power consumption, are susceptible to electromagnetic interference and noise, and have poor wear resistance. In the new long-stroke VCM (Voice Coil Motor) motor structure, the movement stroke of the mover is relatively long, and the motor power is relatively large. However, when the stroke is too long, there will be a phenomenon of weak magnetic force in the middle of the magnet, thus, the motor power will be greatly affected. The longer the structural length, the smaller the magnetic field, and the smaller the driving force. At the same time, the existing position sensing method can only sense one position by PI, the control accuracy is low, and adverse phenomena such as out-of-step are prone to occur, which cannot meet the increasingly stringent accuracy requirements of today's customers.

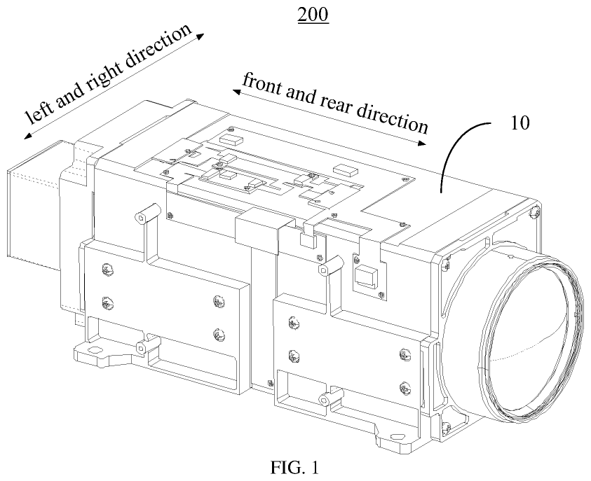

In order to solve the above problems, the present application provides a driving assembly. FIG. 1 is a three-dimensional schematic view of a zoom lens according to an embodiment provided by the present application.

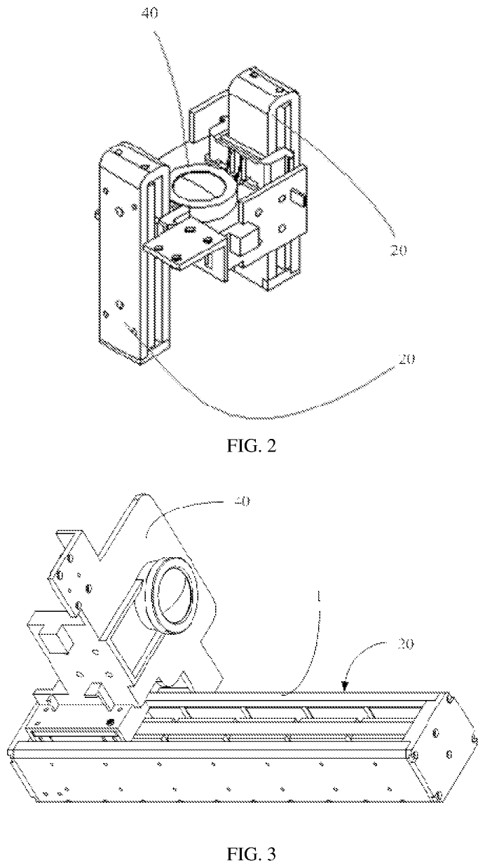

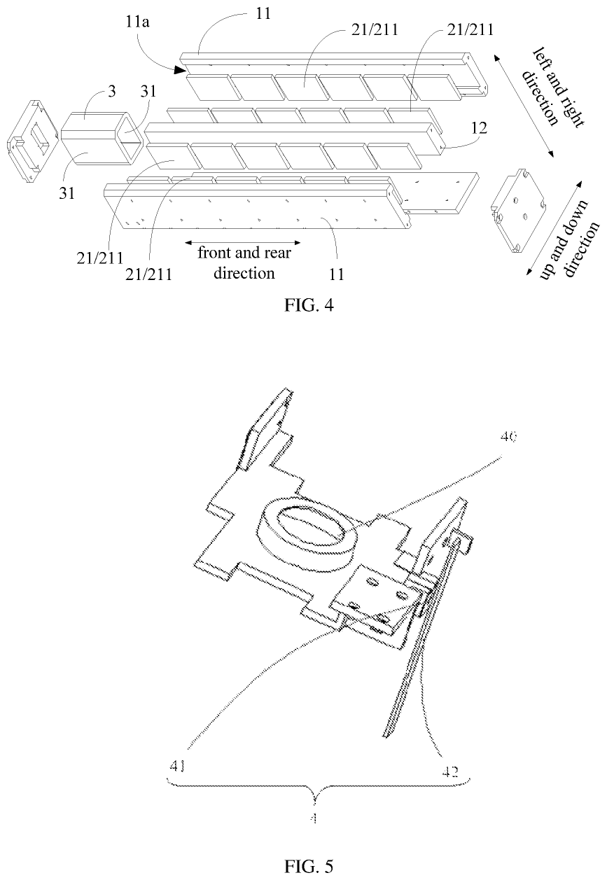

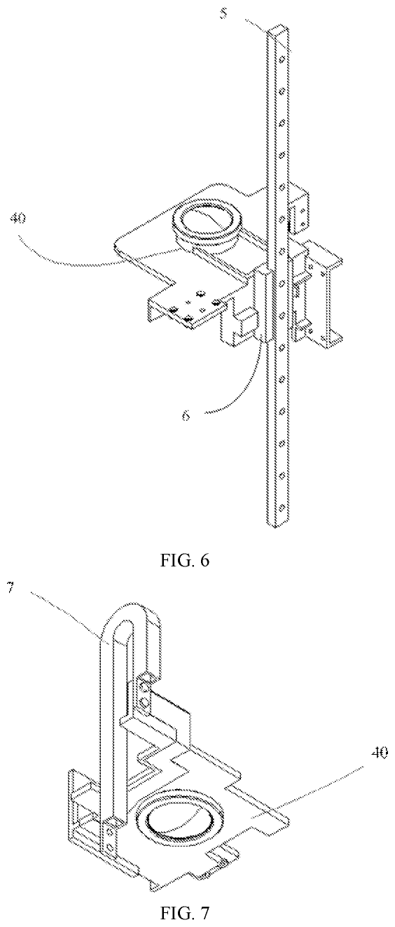

FIG. 2 is a three-dimensional schematic view of a driving assembly according to an embodiment provided by the present application. FIG. 3 is a three-dimensional schematic view of a voice coil motor and a moving group in FIG. 2. FIG. 4 is an exploded schematic view of a voice coil motor in FIG. 2. FIG. 5 is a three-dimensional schematic view of a position detection device and a moving group in FIG. 2. FIG. 6 is a three-dimensional schematic view of a guiding structure and a moving group in FIG. 2. FIG. 7 is a three-dimensional schematic view of a track wire tube and a moving group in FIG. 2.

Refer to FIG. 2 to FIG. 5, the driving assembly 100 includes a seat body structure 10, a voice coil motor 20, a position detection device 4 and a control device. The voice coil motor 20 includes a mounting base 1 fixedly connected to the seat body structure 10, a magnetic body structure 2 and a drive coil 3. The magnetic body structure 2 is fixed at the mounting base 1. The magnetic body structure 2 includes two magnetic circuit assemblies provided at intervals in an up and down direction, each of the magnetic circuit assemblies includes two magnetic bodies 21 provided at intervals in the up and down direction, magnetic poles on sides of the two magnetic bodies 21 close to each other are provided differently, and the two magnetic bodies 21 form a magnetic gap 11a extending along the front and rear direction. The drive coil 3 includes two wire groups 31 provided oppositely in the up and down direction, one of the wire groups 31 is provided in a magnetic gap 11a formed by two magnetic bodies 21 of one magnetic circuit assembly, and the other of the wire groups 31 is provided in a magnetic gap 11a formed by two magnetic bodies 21 of the other magnetic circuit assembly. When the drive coil 3 is energized, the two magnetic circuit assemblies are configured to generate electromagnetic force with the drive coil 3, so as to drive the drive coil 3 to drive a moving group 40 fixed to the drive coil 3 to move along the front and rear direction. The position detection device 4 is configured for detecting a relative position of the drive coil 3 and the magnetic body structure 2 in real time. The control device is electrically connected to the position detection device 4 and the voice coil motor 20, and the control device is configured to control operation of the voice coil motor 20 according to the position detection device 4.

It should be noted that the driving assembly 100 can be configured to drive the moving group 40 in the lens, but is not limited to application in the lens. For equipment with ultra-long driving stroke requirements, the driving assembly 100 according to the present application can also be used. The specific details can be determined according to the actual situation, which is not limited in the embodiments of this specification.

It should be noted that, because that based on the closed-loop real-time feedback position information of the detection device, high-speed driving control can be performed by the driving assembly 100, while increasing the rotational speed, using PID (Proportional-Integral-Derivative) to balance the real-time position, the detection device can promptly detect the position deviation of the voice coil motor 20 and promptly control the voice coil motor 20 to continue working by the control device, thus adjusting the position of the moving group 40, which can effectively improve the zoom speed/focus speed of the moving group 40.

Furthermore, it should be noted that based on the above-mentioned closed-loop control, because the position detection device 4 can feedback position information in real time, even if the voice coil motor 20 has momentary inaccuracy, the moving group 40 can reach the specified target position by the PID control algorithm.

In the technical solution provided by the present application, since the drive coil 3 is provided in an annular shape, the drive coil 3 has two wire groups 31 provided oppositely in the up and down direction, the magnetic body structure 2 includes two magnetic circuit assemblies, and each of the magnetic circuit assemblies includes two magnet bodies 21 with magnetic poles provided differently, and a magnetic gap 11a is formed between the two magnetic bodies 21. A wire group 31 is placed in the magnetic gap 11a formed by the two magnetic bodies 21 of a magnetic circuit assembly, and the other of the wire groups 31 is placed in the magnetic gap 11a formed by the two magnetic bodies 21 of the other magnetic circuit assembly. When the drive coil 3 is energized, the two wire groups 31 are respectively in the magnetic field generated by the two magnetic bodies 21. According to Ampere's rule, the two wire groups 31 are both affected by the Ampere force, so that both the upper side part of the drive coil 3 and the lower side of the drive coil 3 can be moved under the action of Ampere's force. Compared with the situation in the prior art where one side of the coil is in a magnetic field, or magnets 211 are provided at two single sides of the coil, in the present application, both sides of the drive coil 3 are placed in the magnetic gap 11a formed by two magnetic bodies 21, the two magnetic bodies 21 can generate a sufficiently strong magnetic field, when the moving stroke of drive coil 3 is relatively long, the drive coil 3 can also be in a relatively strong magnetic field, two side parts of the drive coil 3 are driven synchronously, and the driving force is also relatively strong. When the driving stroke of the driving assembly 100 is longer, the demand for position accuracy of driving the moving group 40 is higher, the position detection device 4 adopts closed-loop control and can detect the position of the moving group 40 in real time during the stroke of the moving group 40 moving along the front and rear direction. Moreover, the control device adjusts the position of the moving group 40 in real-time according to the displacement difference between the actual position of the lens group and the target position of the lens group, which is not limited by the physical accuracy and wear accuracy of the product itself of the driving mechanism, and is not affected by poor stopping accuracy when the driving assembly 100 drives the moving group 40 at high speed, so that the moving group 40 can accurately reach the target position required for zooming or focusing, and the moving group 40 control can achieve a position detection accuracy of more than 5 um, realizing multi-position induction detection, and accurately sensing any position driven by the voice coil motor 20, so as to propose a driving assembly 100 that has an ultra-long driving stroke and can accurately control the driving accuracy.

In an embodiment, the position detection device 4 includes a magnetic grating transducer including a magnetic head 41 and a magnetic grid 42, the magnetic head 41 is fixedly connected to the drive coil 3, and the magnetic grid 42 is fixedly connected to the seat body structure 10. In this way, the position of the magnetic head 41 can indirectly reflect the position of the moving group 40, and the actual position of the moving group 40 can be accurately detected by the relative movement between the magnetic head 41 and the magnetic grid 42.

It should be noted that the magnetic grid 42 is made by coating a uniform magnetic film on a grid base made of non-magnetic material, and recording magnetic signal grid strips with equal spacing and staggered positive polarity and negative polarity. The magnetic head 41 has two types: dynamic magnetic head 41 (speed response magnetic head 41) and static magnetic head 41 (flux response magnetic head 41). The dynamic magnetic head 41 has an output winding, and a signal can be output only when the magnetic head 41 and the magnetic grid 42 move relative to each other. The static magnetic head 41 has two windings, that is, an exciting winding and an output winding, and it can also have signal output when it is relatively stationary with the magnetic grid 42. The static magnetic head 41 is a multi-gap core with unequal effective cross-sections stacked from iron-nickel alloy sheets. The exciting winding acts like a magnetic switch. When alternating current is applied to the exciting winding, the section of the magnetic circuit with a smaller cross-section of the iron core is excited twice a week to produce magnetic saturation, so that the magnetic lines of force generated by magnetic grid 42 cannot pass through the iron core. Only when the exciting current crosses zero twice a week, the iron core is not saturated, the magnetic lines of force of magnetic grid 42 can pass through the iron core. At this time, the output winding has an induced potential output. Its frequency is twice the frequency of the exciting current, and the amplitude of the output voltage is proportional to the magnetic flux entering the iron core, that is, related to the position of the magnetic head 41 relative to the magnetic grid 42. The magnetic head 41 is made with multiple gaps in order to increase the output, and its output signal is the average of the signals obtained from multiple gaps, so the output accuracy can be improved.

In another embodiment, the position detection device 4 includes an optical grating transducer including a scale grating and an indication grating, the scale grating is fixedly connected to the drive coil 3, and the indication grating is fixedly connected to the seat body structure 10. In this way, the position of the indication grating can indirectly reflect the position of the moving group 40, and the actual position of the moving group 40 can also be accurately detected by the relative movement between the indication grating and the scale grating.

It should be noted that the optical grating transducer refers to a transducer that uses the grating moiré fringe principle to measure displacement. An optical grating is an optical device composed of a large number of parallel slits of equal width and equal spacing. Commonly used optical gratings are made by engraving a large number of parallel grooves on a glass plate. The notch is the opaque part, and the smooth part between the two notches can transmit light, which is equivalent to a seam. Refined optical gratings have thousands or even tens of thousands of gaps within 1 cm width. This kind of optical grating that utilizes the diffraction of transmitted light is called a transmission grating. The moiré fringes formed by the optical grating have optical amplification effect and average error effect, which can improve measurement accuracy. General optical grating transducer consists of four parts: scale grating, indication grating, optical path system and measurement system. When the scale grating moves relative to the indication grating, it forms light and dark moiré fringes that are roughly sinusoidally distributed. These fringes move at the relative speed of the optical grating and shine directly on the photovoltaic element. A series of electrical pulses is obtained at its output. Digital signal output is generated by amplification, shaping, direction identification and counting systems to directly display the measured displacement.

Specifically, refer to FIG. 4, in this embodiment, each of the magnetic bodies 21 includes a plurality of magnets 211 provided at intervals in sequence along the front and rear direction. In this way, the magnet 211 can be used as a minimum unit that provides a magnetic field, and the voice coil motor 20 can reasonably set the number of the magnet 211 according to the required driving stroke length. Moreover, a plurality of magnets 211 are provided, thus each magnet 211 is also more stable. In addition, the magnet 211 requires a small volume, so that the mounting base 1 has small volume requirements and low demand costs.

In this embodiment, the mounting base 1 is configured as a magnetic yoke, the magnetic yoke is configured to form an installing groove provided with an opening, the opening is provided at one side of the magnetic yoke in a left and right direction, the opening is configured to extend along the front and rear direction, and the magnetic body structure 2 and the drive coil 3 are both provided in the installing groove. It should be noted that the magnetic yoke is made of magnetic materials. Magnetic materials refer to a material that can effectively concentrate and guide magnetic lines of force, and it is generally set to iron, steel, ferrite, etc. The magnetic yoke surrounds the outer periphery of the plurality of magnetic bodies 21, which can limit the loss of the magnetic field, improve the utilization of the magnetic field, and protect the coil from external interference.

Specifically, in this embodiment, the magnetic yoke includes two first magnetic yokes 11 extending along the front and rear direction and provided at intervals in the up and down direction, and one side of each first magnetic yoke 11 facing another first magnetic yoke 11 is fixed to one magnetic body 21. The first magnetic yoke 11 guides the magnetic lines of force from a pole end of one magnetic body 21 to a pole end of another magnetic body 21, thus forming a closed magnetic circuit to provide a path with low magnetic resistance, so that the magnetic lines of force can flow more efficiently, thereby increasing the strength and stability of the magnetic field. In this way, each of magnetic bodies 21 is fixedly attached to one side of the corresponding first magnetic yoke 11 to limit the dissipation of the magnetic field in the up and down direction, thereby improving the utilization of the magnetic field in the up and down direction.

At the same time, the installing groove is further provided with a second magnetic yoke 12 located between the two magnetic circuit assemblies and extending along the front and rear direction, and two side parts of the second magnetic yoke in the up and down direction are respectively provided with one magnetic body 21. The two magnet bodies 21 are in close contact with the drive coil 3, which can not only enhance the focusing effect of the magnetic field, but also transfer the magnetic field to the drive coil 3 to improve the utilization of the magnetic field.

Furthermore, since the driving stroke of the driving assembly 100 is extremely long, in order to enable the driving assembly 100 to strictly follow the set straight line, thus, refer to FIG. 6, in this embodiment, the driving assembly 100 further includes a guide mechanism including a guide rail 5 provided at one of the seat body structure 10 and the moving group 40, and a slide block 6 provided at the other of the seat body structure 10 and the moving group 40; the guide rail 5 is configured to extend along the front and rear direction, the slide block 6 is concavely provided with a slide groove slidingly matched with the guide rail 5, the guide mechanism further includes a rolling part provided between an inner wall of the slide groove and the guide rail 5, and the moving group 40 is supported at the guide rail 5 by the rolling part when the moving group 40 is configured to move relative to the seat body structure 10 along the front and rear direction. Setting in this way, when the moving group 40 moves in the front and rear direction relative to the seat body structure 10, two side walls of the slide groove limit the two side walls of the guide rail 5, so that the moving group 40 can move along the extension direction of the guide rail 5. Furthermore, the moving group 40 is supported at the guide rail 5 by the rolling part, the contact area between the rolling part and the guide rail 5 or the contact area between the rolling part and the inner wall of the slide groove is relatively small, which is just a point or a small area, in comparison, sliding friction will lead to a relatively large contact area, thus generating greater friction. Moreover, the rolling part transmits force by rolling motion, reducing the relative motion between direct contact surfaces in sliding friction, thereby reducing friction. The rolling friction between the rolling part and the guide rail 5 or the rolling friction between the rolling part and the inner wall of the slide groove can further reduce energy loss and heat generation, thus improving the efficiency and lifespan of the system.

Furthermore, since the movement of the drive coil 3 requires a wire lead, the structural form of movement of the TMR (Tunnel Magneto Resistance) position sensor also requires a wire lead to the outer end of the lens, the traditional lead method is the structural style of a FPC (Flexible Printed Circuit) flexible flat cable, while the driving assembly 100 is configured to have the structural style of an ultra-long stroke and ultra-large load force. Therefore, using the structure of FPC flexible flat cable, the lifespan, stroke, heating, magnetic interference, etc. are difficult to meet the needs of ultra-long stroke and ultra-large load. Refer to FIG. 7, in this embodiment, the driving assembly 100 further includes a wire harness and a track wire tube 7, one end of the wire harness is connected to the drive coil, and the other end of the wire harness is connected to a power supply, the track wire tube 7 includes a plurality of tube sections, every two adjacent tube sections are rotationally connected, the plurality of the tube sections are provided to be communicated in sequence to form an installation passage for the wire harness to be sleeved, and the wire harness is passed through the installation passage. In this way, the use of a track-like wiring structure can protect the wire harness well, and prevent the wire harness from interfering with other components during the movement of the moving group 40.

The present application further provides a zoom lens 200, and the zoom lens 200 includes the above-mentioned driving assembly 100. The zoom lens 200 further includes a moving group 40, a fixed group and so on. Since the zoom lens 200 includes the driving assembly 100, the specific structure of the driving assembly 100 refers to the above embodiment. Since the driving assembly 100 of the zoom lens 200 adopts all the technical solutions of all the above embodiments, the driving assembly 100 of the zoom lens 200 has at least all the beneficial effects brought by the technical solutions of the above embodiments, which will not be described again here.

Specifically, in this embodiment, the zoom lens 200 further includes a lens barrel and a moving group 40, the lens barrel includes the seat body structure 10; and the moving group 40 is fixedly connected to the drive coil 3. It can be understood that the moving group 40 may be a zoom lens group or a focusing lens group.

The present application further provides a camera device. The camera device includes a security monitor, a photography camera, or an intelligent terminal equipment. The camera device includes the above-mentioned zoom lens 200. The camera device further includes a moving group 40, a fixed group and so on. Since the camera device includes the zoom lens 200, the specific structure of the zoom lens 200 refers to the above embodiment. Since the zoom lens 200 of the camera device adopts all the technical solutions of all the above embodiments, the zoom lens 200 of the camera device has at least all the beneficial effects brought by the technical solutions of the above embodiments, which will not be described again here.

The above are only some embodiments of the present application, and are not intended to limit the scope of the present application. Under the concept of the present application, any equivalent structure transformation made by using the description and accompanying drawings of the present application, or directly or indirectly applied in other related technical fields, is included within the scope of the present application.

What is claimed is:

1. A driving assembly, comprising:
a seat body structure;
a voice coil motor comprising a mounting base fixedly connected to the seat body structure, a magnetic body structure and a drive coil, wherein the magnetic body structure is fixed at the mounting base, and the magnetic body structure comprises two magnetic circuit assemblies provided at intervals in an up and down direction; each of the magnetic circuit assemblies comprises two magnetic bodies provided at intervals in the up and down direction; magnetic poles on sides of the two magnetic bodies close to each other are provided differently, and the two magnetic bodies are configured to form a magnetic gap extending along a front and rear direction; the drive coil comprises two wire groups provided oppositely in the up and down direction; one of the wire groups is provided in a magnetic gap formed by two magnetic bodies of one magnetic circuit assembly, and the other of the wire groups is provided in a magnetic gap formed by two magnetic bodies of the other magnetic circuit assembly; when the drive coil is energized, the two magnetic circuit assemblies are configured to generate electromagnetic force with the drive coil, so as to drive the drive coil to drive a moving group fixed to the drive coil to move along the front and rear direction;
a position detection device configured for detecting a relative position of the drive coil and the magnetic body structure in real time; and
a control device electrically connected to the position detection device and the voice coil motor, wherein the control device is configured to control operation of the voice coil motor according to the position detection device.

2. The driving assembly according to claim 1, wherein the position detection device comprises a magnetic grating transducer comprising a magnetic head and a magnetic grid; the magnetic head is fixedly connected to the drive coil, and the magnetic grid is fixedly connected to the seat body structure.

3. The driving assembly according to claim 1, wherein the position detection device comprises an optical grating transducer comprising a scale grating and an indication grating; the scale grating is fixedly connected to the drive coil, and the indication grating is fixedly connected to the seat body structure.

4. The driving assembly according to claim 1, wherein each of the magnetic bodies comprises a plurality of magnets provided at intervals in sequence along the front and rear direction.

5. The driving assembly according to claim 1, wherein the mounting base is configured as a magnetic yoke; the magnetic yoke is configured to form an installing groove provided with an opening, and the opening is provided at one side of the magnetic yoke in a left and right direction; the opening is configured to extend along the front and rear direction, and the magnetic body structure and the drive coil are both provided in the installing groove.

6. The driving assembly according to claim 5, wherein the magnetic yoke comprises two first magnetic yokes extending along the front and rear direction and provided at intervals in the up and down direction, and one side of each first magnetic yoke facing the other first magnetic yoke is fixed to one magnetic body; and
the installing groove is further provided with a second magnetic yoke located between the two magnetic circuit assemblies and extending along the front and rear direction, and two side parts of the second magnetic yoke in the up and down direction are respectively provided with one magnetic body.

7. The driving assembly according to claim 1, wherein the driving assembly further comprises a guide mechanism comprising a guide rail provided at one of the seat body structure and the moving group, and a slide block provided at the other of the seat body structure and the moving group; the guide rail is configured to extend along the front and rear direction; the slide block is concavely provided with a slide groove slidingly matched with the guide rail, and the guide mechanism further comprises a rolling part provided between an inner wall of the slide groove and the guide rail; the moving group is supported at the guide rail by the rolling part when the moving group is configured to move relative to the seat body structure along the front and rear direction.

8. The driving assembly according to claim 1, wherein the driving assembly further comprises a wire harness and a track wire tube; one end of the wire harness is connected to the drive coil, and the other end of the wire harness is connected to a power supply; the track wire tube comprises a plurality of tube sections, and every two adjacent tube sections are rotationally connected; the plurality of the tube sections are provided to be communicated in sequence to form an installation passage for the wire harness to be sleeved, and the wire harness is passed through the installation passage.

9. A zoom lens comprising the driving assembly according to claim 1.

10. The zoom lens according to claim 9, further comprising:
a lens barrel comprising the seat body structure; and
a moving group fixedly connected to the drive coil.

11. A camera device comprising the zoom lens according to claim 9, wherein the camera device comprises a security monitor, a photography camera, or an intelligent terminal equipment.
